(19) United States
(12) Patent Application Publication
(10) Pub. No.: US 2022/0135463 A1
(43) Pub. Date: May 5, 2022

(54) METHODS AND APPARATUS FOR FREE-FORM CUTTING OF FLEXIBLE THIN GLASS

(71) Applicant: Corning Incorporated, Corning, NY (US)

(72) Inventor: XINGHUA LI, Horseheads, NY (US)

(21) Appl. No.: 17/426,013

(22) PCT Filed: Jan. 22, 2020
(86) PCT No.: PCT/US2020/014514

§ 371 Date: Jul. 28, 2021

Related U.S. Application Data
(60) Provisional application No. 62/798,095, filed on Jan. 29, 2019.

(51) Int. Cl. C03B 33/04; C03B 33/09; C03B 33/10; C03B 33/033; C03B 33/02; B23K 26/364; B23K 26/38; B23K 26/402; B23K 26/60

(52) U.S. Cl. CPC C03B 33/04; C03B 33/091; C03B 33/102; C03B 33/033; B23K 2101/18; B23K 26/364; B23K 26/38; B23K 26/402; B23K 26/60; C03B 33/0222

(57) ABSTRACT

Methods and apparatus provide for: supporting a source glass sheet of 0.3 millimeters (mm) or less in thickness; scoring the glass sheet at an initiation line using a mechanical scoring device; applying a carbon monoxide (CO) laser beam to the glass sheet starting at the initiation line and continuously moving the laser beam relative to the glass sheet along a cutting line to elevate a temperature of the glass sheet to provide stress at the cutting line sufficient to cut the glass; and separating waste glass from the glass sheet to obtain a desired shape.

### CROSS-REFERENCE TO RELATED APPLICATION

This application claims the benefit of priority under 35 U.S.C. § 119 of U.S. Provisional Application Ser. No. 62/798095 filed on Jan. 29, 2019, the content of which is relied upon and incorporated herein by reference in its entirety.

### BACKGROUND

The present disclosure relates to methods and apparatus for fabricating flexible thin glass into free-form shapes, and more particularly for use in providing some improved protection of other material layers, for example one or more polymer layers.

Conventional manufacturing techniques for cutting flexible polymer (plastic) substrates have been developed, where the plastic substrates employ a plastic base material laminated with one or more polymer films. These laminated structures are commonly used in flexible packaging associated with photovoltaic (PV) devices, organic light emitting diodes (OLED), liquid crystal displays (LCD) and patterned thin film transistor (TFT) electronics, mostly because of their relatively low cost and demonstrably reliable performance.

Although the aforementioned flexible plastic substrates have come into wide use, they nevertheless exhibit poor characteristics in connection with at least providing a moisture barrier and providing very thin structures (indeed, the structures are relatively thick owing to the properties of plastic materials).

Accordingly, there are needs in the art for new methods and apparatus for fabricating a flexible substrate for use in, for example, PV devices, OLED devices, LCDs, TFT electronics, etc., particularly where the substrate is to provide a moisture barrier and the substrate is to be formed into a free-form shape.

### SUMMARY

The present disclosure relates to employing a relatively thin, flexible, glass sheet (on the order of less than about 0.3 millimeters (mm)) and cutting the glass sheet into a free form shape by separating one portion thereof from another portion.

Flexible glass substrates in accordance with disclosed embodiments herein offer several technical advantages over the existing flexible plastic substrates in conventional use. One technical advantage is the ability of the glass substrate to serve as good moisture or gas barrier, which is a primary degradation mechanism in outdoor applications of electronic devices. Another advantage is the potential for the flexible glass substrate to reduce the overall package size (thickness) and weight of a final product through the reduction or elimination of one or more package substrate layers. As the demand for thinner, flexible substrates (on the order of less than about 0.3 mm thick) increases in the electronic display industry, manufacturers are facing a number of challenges for providing suitable flexible substrates.

A significant challenge in fabricating flexible glass substrate for PV devices, OLED devices, LCDs, TFT electronics, etc., is cutting a source of relatively large, thin glass sheet into smaller discrete substrates of various dimensions and shapes with tight dimensional tolerances, good edge quality, and high edge strength. Indeed, a desired manufacturing parameter is to cut glass parts off a source glass sheet continuously, without interruption of the cutting line, where the cutting line includes at least some round sections (e.g., for rounded corners), possibly of varying radii.

Although existing mechanical techniques for continuous cutting of irregular (free form) shapes provide for scoring (with a score wheel) and mechanical breaking (or snapping), the edge quality and strength achieved by such mechanical techniques are not sufficient for many applications where precision is desired. Indeed, the mechanical scoring and breaking approach generates glass particles and manufacturing failures, which decreases the process yield and increases manufacturing cycle time.

Moreover, the cutting of thin flexible glass with thicknesses of less than about 0.3 mm presents significant challenges, especially when tight dimensional tolerances and high edge strength are desired manufacturing objectives. Although carbon dioxide (CO2) laser cutting techniques have been employed to cut very thin glass sheets into free form shapes, the existing techniques may have some drawbacks.

First, many of the existing glass cutting techniques using a laser are directed to cutting glass sheets having thicknesses of at least 0.4 mm and thicker, for example laser scoring followed by mechanical breaking (score and snap). The conventional laser score and mechanical break process is nearly impossible to reliably employ with glass sheet thicknesses of less than about 0.3 mm, and especially of less than about 0.2 mm. Indeed, due to the relatively thin profile of a glass sheet of less than about 0.3 mm, the stiffness of the sheet is very low (i.e., the sheet is flexible), and the laser score and snap cutting process is easily adversely affected by thermal buckling, mechanical deformation, air flows, internal stress, glass warpage, and many other factors.

Second, although at least one carbon dioxide (CO2) laser cutting technique has been employed to cut a glass sheet of less than about 0.3 mm, including rounded corners, such glass exhibits relatively high absorption of the mid-to-far infrared light energy of the carbon dioxide (CO2) laser, which is in the 9.2-11.2 micrometers (um, microns) wavelength. Thus, overheating of the glass substrate is a significant issue when employing carbon dioxide (CO2) lasers in the cutting process. The existing carbon dioxide (CO2) laser techniques go to great lengths and complexities to address the overheating issue, including making the size of the laser beam relatively large (greater than 1 mm), making the speed of movement of the laser beam over straight sections of the cut relatively fast (greater than 1 meter per second), and varying the speed and power of the laser beam over straight and rounded sections of the cutting line.

In contrast, the embodiments herein present a carbon monoxide (CO) laser cutting technique resulting in free form shapes of thin flexible glass, whereby a one-step full separation of the free form shape from the source glass sheet is achieved along virtually any trajectory, including closed contours. A continuous cutting trajectory may be established using a combination of any number of cutting lines having radii of curvature from a minimum of about 2 mm up to a straight line.

The novel methodology and apparatus provides for the propagation of a crack in the source glass sheet via a carbon monoxide (CO) laser and simultaneous provision of a cooling fluid (for example a gas, for example air, that, together with the laser heating, generates a stress differential to drive a crack along an intended path in the glass). Initiation of the crack is achieved using a mechanical tool or laser ablation using another short-pulse laser, preferably outside a perimeter of the desired cutting line. The methodology and apparatus is applicable to thin and ultra-thin glass sheets with thicknesses of less than about 0.3 mm, for example from about 0.03 mm to about 0.3 mm, and/or from about 0.05 mm to about 0.2 mm. Notably, cutting of thinner glass sheets is possible, and the cutting of thicker glass sheets (for example, greater than about 0.3 mm) is also possible.

Advantages of the embodiments herein include: (i) producing free form glass shapes from thin and ultra-thin glass sheets with high edge quality and precision; (ii) the flexibility to cut various shapes and sizes; (iii) permitting a cut having a minimum radius of curvature of about 2 mm; (iv) reproducible and effective crack initiation and crack termination; (v) high edge strength and clean cutting process; (vi) very simple and low cost beam shaping optics, beam delivery optics, and power laser source; and/or (vii) application to a wide range of glass thicknesses (including ultra-thin glass sheets).

Other aspects, features, and advantages will be apparent to one skilled in the art from the description herein taken in conjunction with the accompanying drawings.

### DESCRIPTION OF THE DRAWINGS

For the purposes of illustration, there are forms shown in the drawings that are presently preferred, it being understood, however, that the embodiments disclosed and described herein are not limited to the precise arrangements and instrumentalities shown.

FIG. 1 is top view of a thin, glass substrate produced using one or more cutting methodologies and apparatus disclosed herein;

FIG. 2 is a top view of a source glass sheet from which the glass substrate of FIG. 1 may be produced;

FIG. 3 is a graphical representation of the light transmission percentages of a carbon dioxide (CO2) laser beam versus a carbon monoxide (CO) laser beam through glass as a function of glass thickness (ranging from 0 to 300 um thickness);

FIG. 4 is a schematic illustration of an apparatus that may be used to cut the glass substrate from the glass sheet in accordance with a first approach; and

FIG. 5 is a schematic illustration of an alternative apparatus that may be used to cut the glass substrate from the glass sheet in accordance with a second approach.

### DETAILED DESCRIPTION OF THE PREFERRED EMBODIMENTS

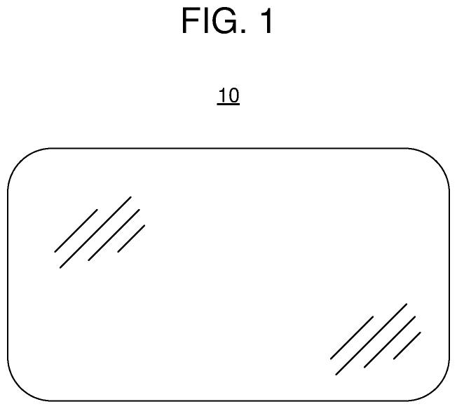

With reference to the drawings wherein like numerals indicate like elements there is shown in FIG. 1 a top view of a thin, glass substrate 10 produced using one or more cutting methodologies and apparatus disclosed herein. A number of characteristics of the glass substrate 10 are of importance when considering the disclosure herein.

First, the glass substrate 10 (and the source glass sheet from which it is cut) is thin and/or ultra-thin, with a thickness of less than about 0.3 mm, for example from about 0.03 mm to about 0.3 mm, and/or from about 0.05 mm to about 0.2 mm. In addition, as will be discussed in greater detail later herein, it has been discovered that particular embodiments exhibit significant advantages when cutting a glass substrate 10 of a thickness of about 0.1 mm or less. While these thicknesses are considered preferable, and representative of thicknesses not heretofore usable in connection with existing free-form shape cutting techniques, the glass substrate 10 may be thinner and/or thicker than the ranges mentioned.

Second, the glass substrate 10 is considered a free form shape, for example having at least one curved portion, and indeed potentially a plurality of curved portions, having one or more radii of curvature anywhere from a minimum of about 2 mm up to infinity (which is a straight line). For example, the glass substrate 10 is shown with four rounded corners, although any other shape may be employed, for example having a mix of rounded corners, sharp corners, straight beveled corners, notches, etc.

Third, the glass substrate 10 is intended to be formed via a one step, full separation cutting methodology in which the desired shape is obtained from a thin source glass sheet.

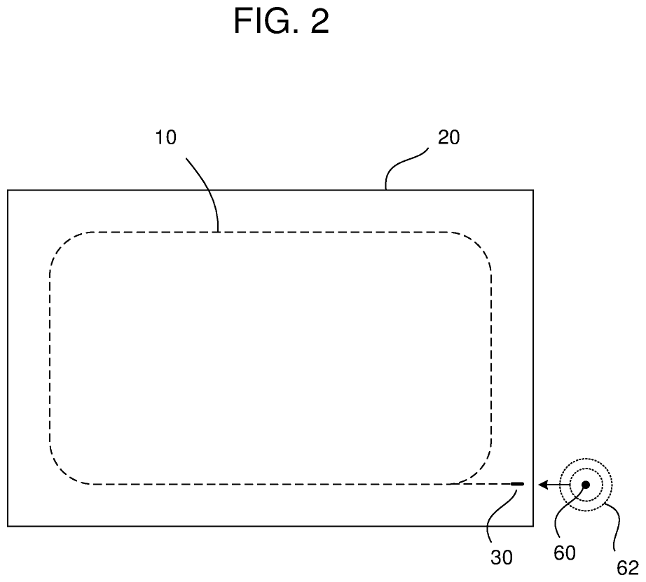

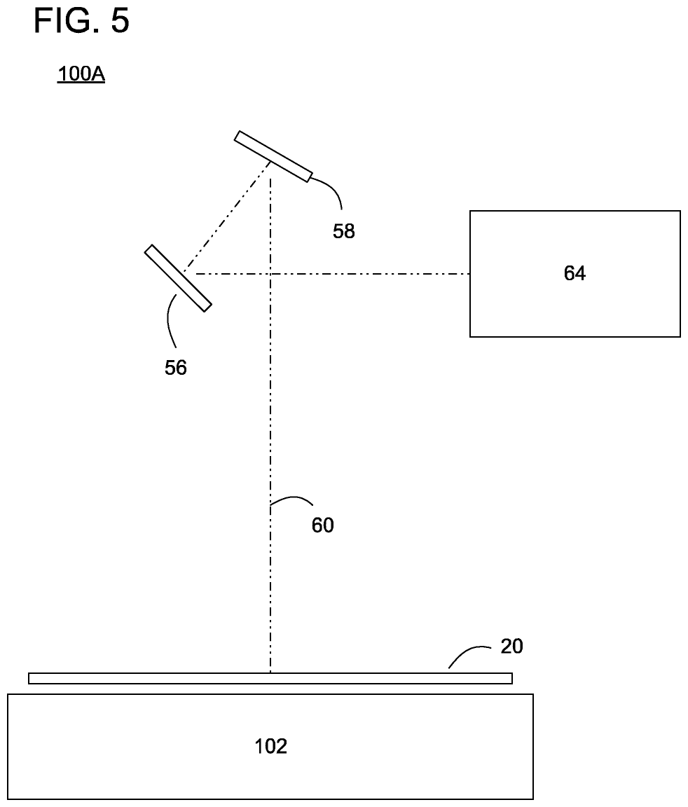

Reference is now made to FIG. 2, which is a top view of a source glass sheet 20 from which the glass substrate 10 of FIG. 1 may be produced. It is noted that the embodiment disclosed in FIG. 2 is a first of two approaches to cutting the source glass sheet 20 from which the glass substrate 10, where an alternative, second approach is disclosed later herein (see, FIG. 5).

The novel methodology and apparatus disclosed in FIG. 2 provides for cutting the glass substrate 10 via propagation of a crack in the source glass sheet using a carbon monoxide (CO) laser beam and simultaneous provision of a cooling fluid (for example a gas, for example air that, together with the laser heating, generates a stress differential to drive a crack along an intended path in the glass). In general, this arrangement results in the controlled propagation of the crack in the source glass sheet along a desired cutting line to separate the glass substrate 10 from the glass sheet 20. A more detailed discussion of the methodology and apparatus for carrying out the initiation, propagation, and termination of the crack is provided later in this description.

As an initial phase of the process, the source glass sheet 20 (of the aforementioned thickness) is supported on a suitable support structure and a free form cutting line (the dashed line in FIG. 2) is defined that establishes a closed pattern, where the cutting line circumscribes the desired final shape of the glass substrate 10.

There are a number of options for the start of the cutting line and the finish of the cutting line. For example, one option is that the start and finish of the cutting line are co-incident. Alternatively, the start 30 of the cutting line may be at a different point as compared to the finish of the cutting line.

An important parameter in connection with achieving suitable cut edge quality on the finished glass substrate 10 is the initiation of a crack over a small length on the glass sheet 20, which is subsequently propagated using the aforementioned laser cutting technique. In general, the glass sheet 20 is scored at an initiation line (the initial crack at 30) using a mechanical scoring device, for example a score wheel. So that the significance of the crack initiation and subsequent propagation of the crack can be better understood and appreciated, a more detailed discussion of the laser cutting technique will first be provided.

The laser is used to heat the glass sheet 20 in a localized area and then a cooling fluid is used to rapidly cool that area to create transient tensile stress via the resultant temperature gradient. The aforementioned initial crack (initiation line) is created by introducing a small initial flaw on the surface of the glass sheet 20, which is then transformed into a vent (the crack) propagated by heating the localized zone via the laser and cooling that zone via quenching action produced by the cooling fluid. The tensile stress, σ, produced during the process is proportional to α*E*ΔT, where α is a linear thermal expansion coefficient of the glass sheet 20, E is a modulus of elasticity of the glass sheet 20, and ΔT is a temperature difference on the surface of the glass sheet 20 produced by the heating (from the laser) the cooling (from the fluid). The tensile stress is controlled to be higher than the molecular bonds of the glass sheet 20. For a given α*E tensile stress, σ can be increased by heating the glass sheet 20 to a higher temperature via the laser. The described method uses full body glass separation (that is, cutting), where the vent depth is equal to the thickness of the glass. The term cutting, when referring to glass, is used herein to mean full body separation of the glass.

A critical issue with the aforementioned laser cutting technique is to avoid overheating the glass sheet 20 (above its strain point). Indeed, such overheating may cause significant ablation and irreversible high residual stress, which deteriorates the quality of the cut edge and reduces edge strength. In many instances, the resultant deterioration in the quality of the cut edge may render the item unsatisfactory to an end user and/or unacceptable for use in a commercially viable product.

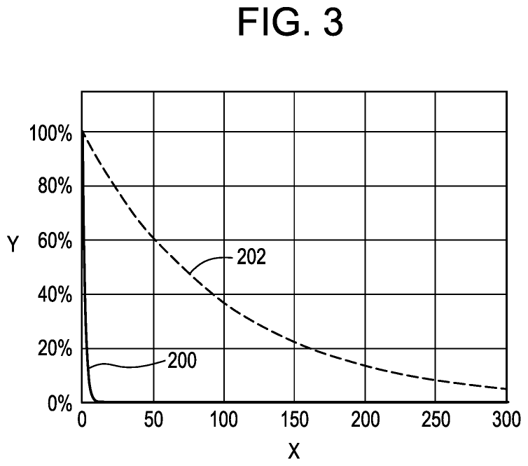

The existing carbon dioxide (CO2) laser cutting techniques are prone to causing the aforementioned overheating due to the characteristics of the light energy of the laser beam and the characteristics of the glass sheet 20. In this regard, reference is made to FIG. 3, which is a graphical representation of the light transmission percentages through a glass sheet of light energy emitted from a carbon dioxide (CO2) laser beam (curve 200) versus a carbon monoxide (CO) laser beam (curve 202), as a function of glass thickness (ranging from 0 to 100 um thickness). The glass sheet is of a composition commonly used in display glass applications, for example a glass sheet formed from Corning® Eagle XG® glass, which generally have similar transmission characteristics.

The percentage of light energy from a carbon dioxide (CO2) laser beam transmitted through a glass sheet (Y-axis) ranging from 0 um to 300 um (X-axis) is shown by curve 200 in FIG. 3. Notably, the curve 200 is highly non-linear, with nearly 0% transmission (and nearly 100% absorption) of light energy by the glass sheet at thicknesses over about 10 um. This type of non-linear, transmission and/or absorption characteristic is particularly problematic because of the tendency to overheat the glass sheet.

Existing carbon dioxide (CO2) laser cutting techniques incur significant cost, complexity, and special processing to avoid or minimize the overheating issue. Indeed, the wavelength of mid-to-far infrared light energy produced by a carbon dioxide (CO2) laser beam is in the range of 9.2 um-11.2 um, and the penetration depth of the laser beam may be several microns, yielding significant absorption. Consequently, high cutting speeds (greater than 1 meter per second), complex laser power control schemes, special processing in cutting along curves, and other factors combine to place limitations on the dimensional control capability of the carbon dioxide (CO2) laser cutting processes.

Indeed, the aforementioned characteristics of the carbon dioxide (CO2) laser beam require a relatively large laser beam footprint on the glass surface. As mentioned previously, at a given glass thickness, there is a minimum glass temperature to fracture the glass. Since the penetration depth of the light energy of the carbon dioxide (CO2) laser beam is only a few microns, to achieve the desired temperature while trying to minimize the likelihood of overheating the glass, it is necessary to increase laser beam size on the glass surface. For example, a round carbon dioxide (CO2) laser beam may be about 1.5 mm in diameter or larger. Consequently, the stress field in the glass sheet is on the order of millimeters, which is not particularly desirable for edge straightness in applications where an acceptable deviation from perfectly straight is less than a hundreds of microns, for example less than 100 microns, or less than 75 microns, or less than 50 microns, or less than 25 microns, or less than 10 microns. Fractures generated by such a large stress field can wander under minute external influences, thus limiting cutting dimensional control capabilities.

Ultrathin glass (less than about 0.3 mm) is highly flexible because flexural rigidity is proportional to the cube of the glass thickness. Local heating of the glass substrate by a carbon dioxide (CO2) laser beam will likely result in significant local thermal expansion. Notably, such thermal expansion will not be uniform with respect to the glass thickness due to the aforementioned low penetration depth of the carbon dioxide (CO2) laser beam. Consequently, undesirable glass deformations (e.g. thermal buckling, mechanical deformation, glass warpage) occur during the carbon dioxide (CO2) laser cutting process, which alter the stress field needed to maintain a stable fracturing process. One way of minimizing the effect of such glass deformation is to cut the glass sheet at a relatively high speed, for example greater than 1 meters per second. Such high speeds, however, may result in other undesirable process characteristics (e.g. complicated speeds of the movement of the laser beam relative to the glass sheet and/or complicated power control schemes), particularly with regard to cutting along curved portions of the cutting line.

Turning again to FIG. 3, the percentage of light energy from a carbon monoxide (CO) laser beam transmitted through a glass sheet (Y-axis) ranging from 0 um to 300 um (X-axis) is shown by curve 202. Notably, the curve 202 is highly linear, with significant transmission (and relatively low absorption) of light energy by the glass sheet at thicknesses over the entire thickness range 0-300 um. More particularly, curve 202 shows that the characteristics of the glass sheet and the monoxide (CO) laser beam are such that at least one of: (i) an absorption percentage of light energy of the laser beam by the glass sheet is about 80% or less, at least for thicknesses of about 0.1 mm or less; (ii) a transmission percentage of light energy of the laser beam through the glass sheet is about 20% or more, at least for thicknesses of about 0.1 mm or less; (iii) an absorption percentage of light energy of the laser beam by the glass sheet is about 90% or less, at least for thicknesses of about 0.2 mm or less; (iv) a transmission percentage of light energy of the laser beam through the glass sheet is about 10% or more, at least for thicknesses of about 0.2 mm or less; (v) an absorption percentage of light energy of the laser beam by the glass sheet is about 95% or less, at least for thicknesses of about 0.3 mm or less; and (vi) a transmission percentage of light energy of the laser beam through the glass sheet is about 5% or more, at least for thicknesses of about 0.3 mm or less. This type of linear, transmission and/or absorption characteristic has been found to be particularly beneficial in controlling the process parameters in cutting the glass sheet.

Commercially available carbon monoxide (CO) lasers have been far outpaced by carbon dioxide (CO2) lasers, and thus carbon monoxide (CO) lasers have not been typically used in glass cutting techniques. However, as noted above, the absorption of the light energy of the carbon monoxide (CO) laser by the glass sheet is about an order of magnitude smaller than the absorption of the light energy of the carbon dioxide (CO2) laser, which makes using a CO laser for cutting glass counter-intuitive. Notably, the wavelength of the light energy of the carbon monoxide (CO) laser is from about 4 to about 6 um, typically about 5.3 um.

The lower absorption of the light energy of the carbon monoxide (CO) laser by the glass sheet results in a volumetric heating characteristic, which has been found to be far better for cutting of ultrathin glass sheets. Indeed, the carbon monoxide (CO) laser beam may be focused to a smaller beam diameter (less than about 1 mm) without generating residual stress on the glass edges after cutting. The smaller beam diameter improves dimensional control capability of the cutting process. Further, due to the volumetric heating characteristic produced by the carbon monoxide (CO) laser, there is a much lower magnitude of deformation in the ultrathin glass sheet during the cutting process. This, in turn, permits cutting at a moderate speed (less than 1 meter per second) without sacrificing process stability. The cutting process remains stable even through tight curves in the cutting line.

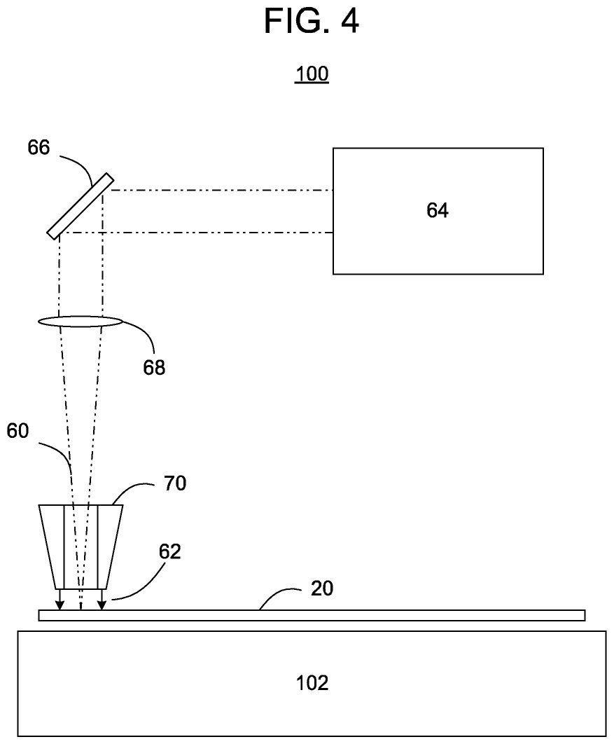

Reference will now be made to FIGS. 2 and FIG. 4, the latter illustrating a system for carrying out a carbon monoxide (CO) laser cutting process on a glass sheet 20 to produce the glass substrate 10. Again, the embodiment disclosed in FIGS. 2 and 4 is a first of two approaches to cutting the source glass sheet 20 from which the glass substrate 10, specifically where both a carbon monoxide (CO) laser and cooling fluid are used to generate a stress to cut the glass sheet 20. An alternative, second approach is disclosed later herein (see, FIG. 5).

The glass sheet 20 may be supported using a support structure 102, which preferably provides the functions of transporting the glass sheet 20 (into and out of the cutting zone of the apparatus 100) and holding the glass sheet 20 during the cutting process. To achieve these functions, the support structure 102 may include one or more of an air bearing mechanism, pressure and/or vacuum mechanisms, etc.

A mechanical tool (a scoring device), for example a cutting wheel, may be used to produce a relatively short crack 30 of sufficient depth in the surface of the glass sheet 20. As illustrated in FIG. 2, the initial crack 30 may be placed outside a perimeter of the desired contour (for example, outside the perimeter of the final glass substrate 10). Alternatively, a short-pulse laser can be used to produce the crack/defect for crack initiation. The short-pulse laser can be one of the following: a nanosecond UV laser, a nanosecond IR or visible laser, a ultrashort (less than 10⁻⁹ s) pulse laser, etc. Laser ablation based initiation process is particularly suitable for ultrathin glass, because mechanical initiation requires mechanical contact and precise control of loading force onto the glass.

The laser beam 60, specifically a carbon monoxide (CO) laser beam, may be implemented using a source 64 of laser energy, folding optics 66, and focusing optics 68. Application of the laser beam 60 to the glass sheet 20 starting at the initiation line (the initial crack 30) initiates propagation of the crack. Continuous moving of the laser beam 60 relative to the glass sheet 20 along the cutting line elevates the temperature of the glass sheet 20 at the cutting line (preferably to a substantially consistent temperature). Simultaneously, the cooling fluid 62 is applied relative to the laser beam 60 (via a nozzle 70), such that the cooling fluid 62 causes a temperature differential in the glass sheet 20 to induce the aforementioned tensile stress and propagate the crack (for example, a fracture or vent) in the glass sheet 20 along the cutting line. Movement of the laser beam 60 and nozzle 70 relative to the glass sheet 20 may be achieved through any of the known conveyance mechanisms.

Free form laser cutting may be achieved using a laser beam 60 of a round shape surrounded by an annular, circular, ring-shaped coolant zone 62 (achieved using the coolant source nozzle 70). The circular laser beam 60, together with the annular coolant zone 62 does not exhibit any predefined or inherent orientation, and therefore can be used to propagate the crack in any direction (without having to use any complex beam shaping techniques or provide any additional motion axes for movement of the nozzle 70). Additionally, while small diameter laser beams are also known for free form laser cutting, the embodiments herein employ a significantly reduced beam diameter of: (i) less than 1 mm; (ii) less than about 0.9 mm; (iii) from 0.8 to 0.9 mm; and (iv) about 0.85 mm.

The source of laser power 64 is implemented using carbon monoxide (CO) laser mechanism operating at the wavelength of from about 4 to about 6 um, for example about 5 um.

Consequently, the characteristics of the glass sheet 20 and the laser beam 60 are such that an absorption and/or transmission percentages of light energy of the laser beam by the glass sheet 20 are substantially linear and comport with the ranges listed above.

The aforementioned absorption and/or transmission characteristics using the carbon monoxide (CO) laser beam 60 permit an advantageous speed of movement of the laser beam 60 relative to the glass sheet 20, specifically at least one of: (i) less than 1 meters per second; (ii) less than about 0.9 meters per second; (iii) less than about 0.8 meters per second; (iv) less than about 0.7 meters per second; (v) less than about 0.6 meters per second; (vi) less than about 0.5 meters per second; (vii) less than about 0.4 meters per second; (viii) less than about 0.3 meters per second; or (ix) less than about 0.2 meters per second.

It has also been found that the above absorption and/or transmission characteristics using the carbon monoxide (CO) laser beam 60 achieves satisfactory cut edge quality on the finished glass substrate 10 because a substantially constant temperature at the cutting line of the glass sheet 20 is achieved, even though the laser beam 60 is traversing a non-straight cutting line.

Moreover, the aforementioned substantially constant temperature at the cutting line of the glass sheet 20 is achieved whilst maintaining one or more cutting parameters substantially constant, for example one or more of: (i) a speed of the movement of the laser beam 60 relative to the glass sheet 20 over an entirety of the cutting line; and (ii) a power level of the laser beam 60 during the movement of the laser beam 60 relative to the glass sheet 20 and over an entirety of the cutting line. At least one, and preferably both, of these parameters may remain substantially constant even whilst the cutting line includes one or more straight sections and one or more curved sections having radii of about 2 mm or higher.

Reference is now made to FIG. 5, which shows an alternative apparatus 100A for, and employing a second approach to, cutting the source glass sheet 20 to form the glass substrate 10. In this embodiment, a carbon monoxide (CO) laser without a source of cooling fluid is used to cut the glass sheet 20. In this embodiment, the thickness of the glass sheet 20 is about 100 um or less. As such, since the glass sheet 20 is ultrathin, there is no need to use forced cooling because the glass sheet 20 exhibits rapid surface convection heat loss sufficient to generate the desired stresses to propagate a vent or crack.

The details of the elements employed in both the apparatus 100 and 100A of similar reference numbers will not be repeated. The laser beam 60, specifically a carbon monoxide (CO) laser beam, may be implemented using duo-axis (XY) optical scanner, employing rotating optical mirrors 56, to move the laser beam 60 along the cutting line. Continuous moving of the laser beam 60 relative to the glass sheet 20 along the cutting line elevates the temperature (preferably to a substantially consistent temperature) of the glass sheet 20 to provide stress at the cutting line sufficient to cut the glass sheet 20. The advantage of an optical scanner is that it has much faster acceleration and deceleration so one can change the cutting trajectory (small corner radii) at high speed. As in the embodiment of FIG. 2, an initiation crack is generated using mechanical initiation or laser ablation based initiation. The laser beam is moved onto the initiation crack 30, and along the defined cutting path. The rapid heating and subsequent convection cooling process generates a tensile stress while promotes a through crack growth along the path of the moving laser beam.

Experiments were conducted to demonstrate the aforementioned carbon monoxide (CO) laser cutting technique on suitable display glass sheets, specifically Corning® ultrathin glass sheets of nominal composition in mol % of: 69.1 SiO2; 10.19 Al2O3; 15.1 Na20; 0.01 K2O; 5.48 MgO; 0.01 Fe2O3; 0.01 ZrO2; and 0.1 SnO2. The glass substrates 20 had a thickness of 35 um. The dimensions of a first target glass substrate 10 was 105 mm×180 mm, with corner radii of 3 mm. The dimensions of a second target glass substrate 10 was 105 mm×180 mm, with corner radii of 3 mm. In each case, a carbon monoxide (CO) laser, running at a 20 kHz repetition rate, 20.6% duty cycle, and power of 20 W, was employed in a configuration similar to that of FIG. 4. The laser beam 60 was focused down to 0.85 mm diameter using an f=750 mm MgF2 lens 68. A duo-axis galvo scanner is used to scan the laser beam 60 along the cutting path at a speed of 0.33 meter per second. A glass substrate 10 having excellent edge quality was achieved.

Although the disclosure herein has been described with reference to particular embodiments, it is to be understood that these embodiments are merely illustrative of the principles and applications of the embodiments herein. It is therefore to be understood that numerous modifications may be made to the illustrative embodiments and that other arrangements may be devised without departing from the spirit and scope of the present application.

Methods and/or apparatus in accordance with embodiments herein may provide for a number of aspects, including: supporting a source glass sheet of 0.3 mm or less in thickness; scoring the glass sheet at an initiation line using a mechanical scoring device; applying a carbon monoxide (CO) laser beam to the glass sheet starting at the initiation line and continuously moving the laser beam relative to the glass sheet along a cutting line to elevate a temperature of the glass sheet to provide stress at the cutting line sufficient to cut the glass sheet along the cutting line; and separating waste glass from the glass sheet to obtain a desired shape.

One or more of the aforementioned aspects of the methods and/or apparatus may further include that a thickness of the source glass sheet is less than about 0.1 mm.

One or more of the aforementioned aspects of the methods and/or apparatus may further include applying a cooling fluid simultaneously with the application of the laser beam, such that the cooling fluid at least reduces the temperature of the glass sheet sufficiently to provide stress that propagates a fracture in the glass sheet along the cutting line to obtain the desired shape.

One or more of the aforementioned aspects of the methods and/or apparatus may further include, wherein the laser beam emits light energy at a wavelength of from about 4 to about 6 um.

One or more of the aforementioned aspects of the methods and/or apparatus may further include, wherein characteristics of the glass sheet and the laser beam are such that at least one of: (i) an absorption percentage of light energy of the laser beam by the glass sheet is about 80% or less, at least for thicknesses of about 0.1 mm or less; (ii) a transmission percentage of light energy of the laser beam through the glass sheet is about 20% or more, at least for thicknesses of about 0.1 mm or less; (iii) an absorption percentage of light energy of the laser beam by the glass sheet is about 90% or less, at least for thicknesses of about 0.2 mm or less; (iv) a transmission percentage of light energy of the laser beam through the glass sheet is about 10% or more, at least for thicknesses of about 0.2 mm or less; (v) an absorption percentage of light energy of the laser beam by the glass sheet is about 95% or less, at least for thicknesses of about 0.3 mm or less; and (vi) a transmission percentage of light energy of the laser beam through the glass sheet is about 5% or more, at least for thicknesses of about 0.3 mm or less.

One or more of the aforementioned aspects of the methods and/or apparatus may further include, wherein the laser beam is of a substantially circular shape having a diameter of one of: (i) less than 1 mm; (ii) less than about 0.9 mm; (iii) from 0.8 to 0.9 mm; and (iv) about 0.85 mm.

One or more of the aforementioned aspects of the methods and/or apparatus may further include, wherein a speed of movement of the laser beam relative to the glass sheet is at least one of: (i) less than 1 meters per second; (ii) less than about 0.9 meters per second; (iii) less than about 0.8 meters per second; (iv) less than about 0.7 meters per second; (v) less than about 0.6 meters per second; (vi) less than about 0.5 meters per second; (vii) less than about 0.4 meters per second; (viii) less than about 0.3 meters per second; or (ix) less than about 0.2 meters per second.

One or more of the aforementioned aspects of the methods and/or apparatus may further include, maintaining a constant speed of the movement of the laser beam relative to the glass sheet over an entirety of the cutting line.

One or more of the aforementioned aspects of the methods and/or apparatus may further include, maintaining a substantially constant power level of the laser beam during the movement of the laser beam relative to the glass sheet and over an entirety of the cutting line.

One or more of the aforementioned aspects of the methods and/or apparatus may further include, wherein the cutting line includes one or more straight sections and one or more curved sections having radii of less than about 10 mm.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When the term “about” is used in describing a value or an end-point of a range, the disclosure should be understood to include the specific value or end-point referred to. Whether or not a numerical value or end-point of a range in the specification recites “about,” the numerical value or end-point of a range is intended to include two embodiments: one modified by “about,” and one not modified by “about.” It will be further understood that the endpoints of each of the ranges are significant both in relation to the other endpoint, and independently of the other endpoint.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, such as within about 5% of each other, or within about 2% of each other.

Directional terms as used herein—for example up, down, right, left, front, back, top, bottom, inward, outward—are made only with reference to the figures as drawn and are not intended to imply absolute orientation.

As used herein the terms “the,” “a,” or “an,” mean “at least one,” and should not be limited to “only one” unless explicitly indicated to the contrary. Thus, for example, reference to “a component” includes embodiments having two or more such components unless the context clearly indicates otherwise.

As used herein, the terms “comprising” and “including,” and variations thereof, shall be construed as synonymous and open ended, unless otherwise indicated. A list of elements following the transitional phrases comprising or including is a non-exclusive list, such that elements in addition to those specifically recited in the list may also be present.

It will be apparent to those skilled in the art that various modifications and variations can be made to the present disclosure without departing from the spirit and scope of the disclosure. Thus, it is intended that the present disclosure cover such modifications and variations provided they come within the scope of the appended claims and their equivalents.

1. A method, comprising:
supporting a source glass sheet of 0.3 millimeters (mm) or less in thickness;
scoring the glass sheet at an initiation line using a mechanical scoring device or a laser ablation process;
applying a carbon monoxide (CO) laser beam to the glass sheet starting at the initiation line and continuously moving the laser beam relative to the glass sheet along a cutting line to elevate a temperature of the glass sheet to provide stress at the cutting line sufficient to cut the glass sheet along the cutting line; and
separating waste glass from the glass sheet to obtain a desired shape.

2. The method of claim 1, further comprising applying a cooling fluid simultaneously with the application of the laser beam, such that the cooling fluid at least reduces the temperature of the glass sheet sufficiently to provide stress that propagates a fracture in the glass sheet along the cutting line.

3. The method of claim 1, wherein the laser beam emits light energy at a wavelength of from about 4 to about 6 um.

4. The method of claim 1, wherein characteristics of the glass sheet and the laser beam are such that at least one of:
(i) an absorption percentage of light energy of the laser beam by the glass sheet is about 80% or less, at least for thicknesses of about 0.1 mm or less;
(ii) a transmission percentage of light energy of the laser beam through the glass sheet is about 20% or more, at least for thicknesses of about 0.1 mm or less;
(iii) an absorption percentage of light energy of the laser beam by the glass sheet is about 90% or less, at least for thicknesses of about 0.2 mm or less;
(iv) a transmission percentage of light energy of the laser beam through the glass sheet is about 10% or more, at least for thicknesses of about 0.2 mm or less;
(v) an absorption percentage of light energy of the laser beam by the glass sheet is about 95% or less, at least for thicknesses of about 0.3 mm or less; and
(vi) a transmission percentage of light energy of the laser beam through the glass sheet is about 5% or more, at least for thicknesses of about 0.3 mm or less.

5. The method of claim 1, wherein a speed of movement of the laser beam relative to the glass sheet is at least one of: (i) less than 1 meters per second; (ii) less than about 0.9 meters per second; (iii) less than about 0.8 meters per second; (iv) less than about 0.7 meters per second; (v) less than about 0.6 meters per second; (vi) less than about 0.5 meters per second; (vii) less than about 0.4 meters per second; (viii) less than about 0.3 meters per second; or (ix) less than about 0.2 meters per second.

6. The method of claim 1, further comprising maintaining a substantially constant speed of the movement of the laser beam relative to the glass sheet over an entirety of the cutting line, wherein the cutting line comprises one or more straight sections and one or more curved sections comprising radii of less than about 10 mm.

7. The method of claim 1, further comprising maintaining a substantially constant power level of the laser beam during the movement of the laser beam relative to the glass sheet and over an entirety of the cutting line, wherein the cutting line comprises one or more straight sections and one or more curved sections comprising radii of less than about 10 mm.

8. An apparatus for cutting a glass sheet into a desired shape, comprising:
a support table operating to support a source glass sheet of 0.3 mm or less in thickness;
a mechanical scoring device or a laser ablation device operating to score the glass sheet at an initiation line;
a laser source operating to apply a carbon monoxide (CO) laser beam to the glass sheet starting at the initiation line and continuously moving the laser beam relative to the glass sheet along a cutting line to elevate a temperature of the glass sheet to provide stress at the cutting line sufficient to cut the glass sheet, such that waste glass may be separated from the glass sheet to obtain a desired shape.

9. The apparatus of claim 8, further comprising a source of cooling fluid operating to apply cooling fluid simultaneously with the application of the laser beam, such that the cooling fluid at least reduces the temperature of the glass sheet sufficiently to provide stress that propagates a fracture in the glass sheet along the cutting line, such that waste glass may be separated from the glass sheet to obtain the desired shape.

10. The apparatus of claim 8, wherein the laser beam emits light energy at a wavelength of from about 4 to about 6 um.

11. The apparatus of claim 8, wherein characteristics of the glass sheet and the laser beam are such that at least one of:
(i) an absorption percentage of light energy of the laser beam by the glass sheet is about 80% or less, at least for thicknesses of about 0.1 mm or less;
(ii) a transmission percentage of light energy of the laser beam through the glass sheet is about 20% or more, at least for thicknesses of about 0.1 mm or less;
(iii) an absorption percentage of light energy of the laser beam by the glass sheet is about 90% or less, at least for thicknesses of about 0.2 mm or less;
(iv) a transmission percentage of light energy of the laser beam through the glass sheet is about 10% or more, at least for thicknesses of about 0.2 mm or less;
(v) an absorption percentage of light energy of the laser beam by the glass sheet is about 95% or less, at least for thicknesses of about 0.3 mm or less; and
(vi) a transmission percentage of light energy of the laser beam through the glass sheet is about 5% or more, at least for thicknesses of about 0.3 mm or less.

12. The apparatus of claim 8, wherein a speed of movement of the laser beam relative to the glass sheet is at least one of: (i) less than 1 meters per second; (ii) less than about 0.9 meters per second; (iii) less than about 0.8 meters per second; (iv) less than about 0.7 meters per second; (v) less than about 0.6 meters per second; (vi) less than about 0.5 meters per second; (vii) less than about 0.4 meters per second; (viii) less than about 0.3 meters per second; or (ix) less than about 0.2 meters per second.

13. The apparatus of claim 8, wherein a speed of the movement of the laser beam relative to the glass sheet is constant over an entirety of the cutting line, wherein the cutting line comprises one or more straight sections and one or more curved sections comprising radii of less than about 10 mm.

14. The apparatus of claim 8, wherein a power level of the laser beam during the movement of the laser beam relative to the glass sheet is substantially constant over an entirety of the cutting line, wherein the cutting line comprises one or more straight sections and one or more curved sections comprising radii of less than about 10 mm.
